(19) United States
(12) Patent Application Publication
(10) Pub. No.: US 2026/0126085 A1
(43) Pub. Date: May 7, 2026

(54) TRANSMISSION DEVICE FOR A DRIVE TRAIN OF A MOTOR VEHICLE, IN PARTICULAR OF AN AUTOMOBILE

(71) Applicant: MERCEDES-BENZ GROUP AG, Stuttgart (DE)

(72) Inventors: Tobias SCHUSTER, Esslingen (DE); Patrik SZÖLLÖSI, Stuttgart (DE); Dennis WINTER, Reichenbach (DE)

(21) Appl. No.: 19/116,477

(22) PCT Filed: Aug. 14, 2023
(86) PCT No.: PCT/EP2023/072399

§ 371 Date: Mar. 28, 2025

(30) Foreign Application Priority Data
Sep. 29, 2022 (DE) 10 2022 003 617.7

(51) Int. Cl. F16D 13/68; F16D 13/64; F16D 13/70

(52) U.S. Cl. CPC F16D 13/683; F16D 13/648; F16D 13/70

(57) ABSTRACT

A transmission device includes a multiple-disc coupling having a disc carrier and a disc pack with discs arranged following each other in the axial direction of the multiple-disc coupling, of which two discs are designed as end discs. A first switching element can actuate the disc pack via a first of the end discs in a first actuating direction extending in the axial direction of the multiple-disc coupling. A second switching element, opposite the first switching element in the axial direction of the multiple-disc coupling, can actuate the disc pack, via the second end disc, in a second actuating direction extending in the axial direction of the multiple-disc coupling and is counter to the first actuating direction. The second end disc is supported in the second actuating direction directly on the disc carrier and in the first actuating direction directly on a component.

### BACKGROUND AND SUMMARY OF THE INVENTION

Exemplary embodiments of the invention relate to a transmission device for a drive train of a motor vehicle, in particular of an automobile.

A coupling for a dual clutch for an automatic or automated dual-clutch transmission of a motor vehicle is taken as known from DE 10 2007 027 120 B4.

Exemplary embodiments of the present invention are directed to a transmission device for a drive train of a motor vehicle, in particular of an automobile, so that a particularly compact construction can be realized.

The invention relates to a transmission device for a drive train of a motor vehicle, also simply referred to as a vehicle, which is preferably formed as an automobile, in particular as a passenger car. This means that, in its completely produced state, the motor vehicle has the transmission device. For example, the motor vehicle with the transmission device can be driven, in particular by a drive motor of the motor vehicle. For example, the drive motor may be an internal combustion engine or also an electric engine, meaning that, for example, the motor vehicle is designed as a hybrid vehicle or also as an electric vehicle, in particular as a battery electric vehicle (BEV).

The transmission device has a multiple-disc coupling which, for example, is arranged in a housing of the transmission device, also referred to as transmission housing. The multiple-disc coupling has at least one disc carrier and a disc pack which, for example, is carried by the disc carrier and therefore is held on the disc carrier. The disc pack has discs that are arranged following each other in the axial direction of the multiple-disc coupling. In particular, exactly two of the discs of the disc pack are end discs, which are also referred to as first discs. The remaining other discs of the disc pack, in particular all remaining discs of the disc pack, are also referred to as second discs and are arranged between the end discs in the axial direction of the multiple-disc coupling.

The transmission device has a first switching element by means of which the disc pack can be actuated via a first of the end discs in a first actuating direction that extends in the axial direction of the multiple-disc coupling. In particular, this is to be understood to mean that the first switching element can exert a first force on the disc pack in the first actuating direction via the first end disc, in order to actuate the disc pack, in particular to compress it or press together it.

In order to be able to realize a particularly advantageous function of the transmission device in a particularly space-efficient manner and thus in a particularly compact design, it is provided according to the invention that the transmission device has a second switching element, provided, in particular, in addition to the first switching element, the second switching element lying opposite the first switching element in the axial direction of the multiple-disc coupling. In particular, the first discs and the second discs of the disc pack are arranged between the switching elements in the axial direction of the multiple-disc coupling. By means of the second switching element, the disc pack can be actuated via the second end disc in a second actuating direction, extending in the axial direction of the multiple-disc coupling and counter to the first direction, in particular in such a way that a second force can be exerted on the disc pack by the second switching element in the second actuating direction via the second end disc. This means, for example, that a so-called disengagement impact can be exerted on the disc pack, in order to separate the discs of the multiple-disc coupling from each other, for example, and thus to disengage the clutch disc. In other words, the second force is or brings about the mentioned disengagement impact, meaning that the second force is a disengagement force in order to disengage the multiple-disc coupling, in particular in order to separate the discs of the disc pack from each other. For example, the multiple-disc coupling can be engaged by means of the first force, in particular in that the disc pack is compressed by means of the first force. If the multiple-disc coupling is engaged, the multiple-disc coupling is in a coupled state, for example, in which two elements are connected to each other for conjoint rotation by means of the multiple-disc coupling, for example. If the multiple-disc coupling is disengaged, the multiple-disc coupling is in a decoupled state, for example, in which the multiple-disc coupling allows relative rotation to take place between the elements, in particular around a longitudinal rotational axis.

The second end disc is supported directly on the disc carrier in the second actuating direction. In the first actuating direction, the second end disc is supported directly on a component of the second switching element and thus a second switching element. This means that space-efficient securing of the disc pack can be realized, wherein the second end disc is loaded on both sides when viewed in the axial direction of the multiple-disc coupling, in particular in that the second end disc is supported in the second actuating direction and thus on one side directly on the disc carrier and is supported in the first actuating direction and thus on the other side directly on the component of the second switching element. The invention thus enables a combined solution for backlash-free axial support of the disc pack, in particular with simultaneous torque support and an opposing axial force component of the second switching element.

In particular, the invention assumes that disc packs of multiple-disc couplings are typically secured axially via a snap ring or securing ring in a toothing of the disc carrier. For example, the disc carrier is an inner disc carrier or outer disc carrier. For example, the disc carrier is the housing. In other words, it is conceivable that the disc carrier is designed as one-piece with the housing, so that the housing and the disc carrier are formed from a single piece. It is also conceivable that the disc carrier and the housing are designed separate from each other and are connected to each other for conjoint rotation. With conventional solutions, a two-sided, axial loading of the respective end disc is not possible without influencing the disc pack, which can now be enabled, however, by the invention. In conventional solutions, as soon as a force acts against an axial force in the disc pack during a gear change, this can have a noticeable negative effect on the shift quality of the transmission device in the motor vehicle. Additionally, disadvantageous surface pressure can arise in the disc pack as a result of a typically small, off-center support surface of the typically used snap ring or securing ring. The aforementioned problems and disadvantages can be avoided by the invention.

The toothing of the disc carrier is also referred to as carrier toothing, for example. For example, the carrier toothing has axial grooves, in particular as tooth gaps, which, for example, are open in the axial direction of the multiple-disc coupling towards the component of the second switching element. In the circumferential direction of the multiple-disc coupling extending around the axial direction of the multiple-disc coupling, for example, an in particular remaining tooth region is arranged between two neighboring axial grooves, in particular as a respective tooth of the carrier toothing, wherein, for example, the discs can be supported or are supported on the teeth of the carrier toothing in the circumferential direction of the disc groups extending around the axial direction, whereby the discs are coupled to the disc carrier in the circumferential direction of the disc coupling in a torque-transmitting manner and in particular for conjoint rotation. In particular, the discs engage into the carrier toothing.

For example, the second end disc has a friction surface which, for example, is facing towards the second discs in the axial direction of the multiple-disc coupling, which are also referred to as intermediate discs. The invention enables a stationary position or positioning of the friction surface of the second inner disc in a space-efficient manner, in particular despite the influence of axial force on both sides, in particular on the second end disc. In particular, in comparison to conventional solutions, the invention enables a reduction of axial installation space, in particular for accommodating a securing ring, for example, for axially securing or installing the second end disc. Compared to conventional solutions, the invention can increase the shifting comfort for the multiple-disc coupling that is designed as a multiple-disc brake, for example, as it is possible, for example, to provide an axially centered force transmission of an axial force onto the second end disc. Compared to using a conventional securing ring, excessive tilting of the second end disc can be prevented.

In an advantageous embodiment of the invention, it is provided that the component supported directly on the second end disc in the second actuating direction is supported in the first actuating direction directly on a securing element that is fixed at least indirectly to a carrier element of the transmission device in the axial direction of the multiple-disc coupling. The carrier element is the housing, for example. In other words, it is conceivable that the carrier element and the housing are designed as one-piece with each other, so that the carrier element and the housing are formed from a single piece. It is also conceivable that the carrier element is designed separately from the housing and is immovably connected to the housing both in a rotationally fixed manner and in the axial direction of the multiple-disc coupling. This means that space-efficient securing of both the component as well as of the second disc can be achieved.

A further embodiment of the invention is characterized in that the securing element is designed as a wedge ring having two wedge surfaces facing away from each other in the axial direction of the multiple-disc coupling, which extend outwards towards each other in the radial direction of the multiple-disc coupling. This means that a backlash-free adjustment of the disc pack can be realized in particular via the component and the second end disc in a particularly compact manner.

In a further, particularly advantageous embodiment of the invention, the discs, i.e., the first discs and the second discs of the disc pack, each have a first toothing that engages into a corresponding second toothing of the disc carrier. Thus, for example, the second toothing is the aforementioned carrier toothing. This means that the discs of the disc pack are supported on the disc carrier in the circumferential direction of the multiple-disc coupling extending around the axial direction of the multiple-disc coupling, and are thereby coupled to the disc carrier in a torque-transmitting manner, in particular for conjoint rotation, in particular for the torques extending in the circumferential direction of the multiple-disc coupling.

In order to be able to realize a particularly compact design, in particular in the axial direction, it is provided in a further embodiment that the second toothing has at least two, in particular at least or exactly three, teeth set back in the axial direction and thereby forming a respective axial end face, on the end faces of which teeth corresponding teeth of the first toothing of the second end disc are directly supported in the second actuating direction. Therefore, a space-efficient, direct support of the second end disc can be guaranteed on the disc carrier. Furthermore, it has been shown to be particularly advantageous if the teeth of the first toothing of the second end disc, which are directly supported on the end faces in the second actuating direction, each have a first extension, extending in the circumferential direction of the multiple-disc coupling, which is greater than a respective second extension of, in particular all, further teeth of the first toothing of the second end disc, the second extension extending in the circumferential direction of the multiple-disc coupling. Therefore, the second end disc can also be supported on the disc carrier in a defined manner and securely even against great axial forces.

In order to avoid excessive, localized loads or load peaks and thus to be able to achieve a particularly compact design, it is provided in a further embodiment of the invention that the teeth of the first toothing of the second end disc, which are directly supported on the end faces in the second actuating direction, are arranged evenly distributed in the circumferential direction of the multiple-disc coupling.

In order to be able to realize a particularly advantageous functionality of the transmission device in a particularly space-saving manner, it is provided in a further embodiment of the invention that a third toothing of the component of the second switching element, corresponding to the second toothing, engages into the second toothing, whereby the component is or can be supported on the disc carrier in the circumferential direction of the multiple-disc coupling. The component is thus a toothed component which is supported, in particular on the disc carrier, in the circumferential direction of the multiple-disc coupling via the same second toothing as the disc pack.

Both the component, as well as the second end disc, can be secured free of backlash, in particular by the wedge ring. Thus, both the disc pack as well as the second switching element can be axially loaded simultaneously, without mutually influencing each other. Additionally, a circumferential load of the second switching element can be supported on the disc carrier and thus for example on the housing via the component, in particular can be introduced into the disc carrier and thus, for example, into the housing. In particular, it is conceivable that both the discs as well as the component, also referred to as a carrier and also designed as a carrier of the second switching element, are connected to the disc carrier for conjoint rotation and thus, for example, to the housing for conjoint rotation, via the second toothing of the disc carrier. In particular, the invention enables integrated torque support of the second switching element. Furthermore, a particularly advantageous surface pressing distribution in the disc pack can be realized by the invention, in particular by at least substantially central support of the second end disc and via this of the second discs on the component.

In order to be able to realize a particularly compact design, it is provided, for example, that the second switching element is designed as a claw switching element and the component is designed as a carrier part of a claw switching element half of the claw switching element.

It is also conceivable that both switching elements are brake switching elements. In this case, it is conceivable that the component is the housing, i.e., it is designed as one-piece with the housing, or the component is designed separately from the housing and is connected to the housing for conjoint rotation.

Further advantages, features and details of the invention can be seen from the following description of a preferred exemplary embodiment and with reference to the drawing. The features and combinations of features mentioned above in the description as well as the features and combinations of features mentioned below in the description of the figures and/or shown alone in the figures can be used not only in the combination indicated in each case, but also in other combinations or on their own, without leaving the scope of the invention.

### BRIEF DESCRIPTION OF THE DRAWING FIGURES

The drawing shows in:

FIG. 1 part of a schematic longitudinal sectional view of a transmission device for a drive train of a motor vehicle;

FIG. 2 part of a further schematic longitudinal sectional view of the transmission device; and

FIG. 3 a schematic front view of a second end disc of the transmission device.

In the figures, identical or functionally identical elements are provided with the same reference numerals.

### DETAILED DESCRIPTION

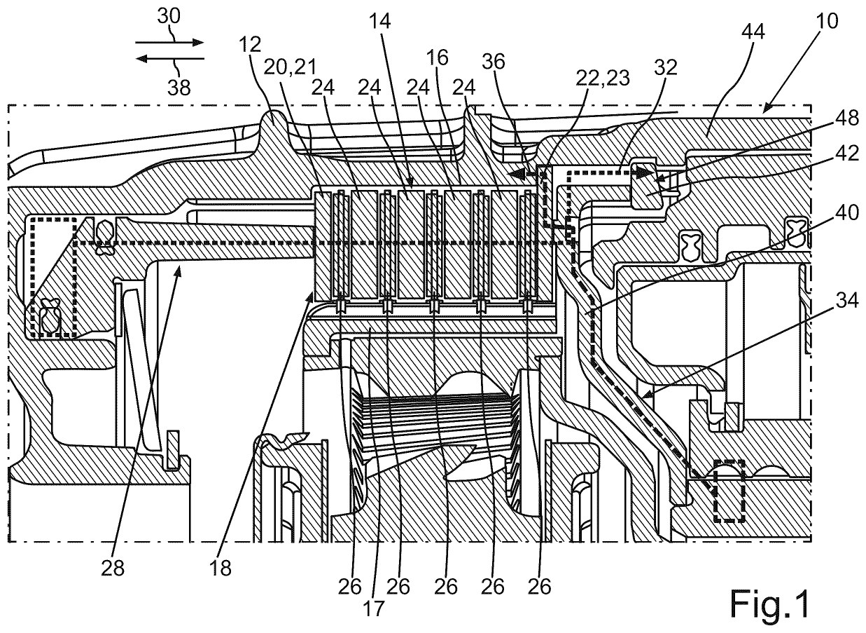

FIG. 1 shows part of a schematic longitudinal sectional view of a transmission device 10 for a drive train of a motor vehicle, also simply referred to as a vehicle. The transmission device 10 has a housing 12, also referred to as transmission housing, and a multiple-disc coupling 14 which is arranged in the housing 12. The multiple-disc coupling 14 has a first disc carrier 16 and a second disc carrier 17. The first disc carrier 16 is an outer disc carrier, and the second disc carrier 17 is an inner disc carrier. For example, the first disc carrier 16 is connected to the housing 12 for conjoint rotation. For example, the first disc carrier 16 is designed as one-piece with the housing 12. If the multiple-disc coupling 14 is opened, i.e., disengaged, the second disc carrier 17 can be rotated around an element rotational axis relative to the first disc carrier 16 and thus relative to the housing 12. If, however, the multiple-disc coupling 14 is closed, i.e., engaged, the second disc carrier 17 is connected to the first disc carrier 16 for conjoint rotation, and thus to the housing 12.

The multiple-disc coupling 14 has a disc pack 18 which has discs 20, 22, and 24. The multiple-disc coupling 14 also has discs 26 which may be component parts of the disc pack 18 or a further disc pack. The discs 20 and 22 are also referred to as first discs of the disc pack 18 and are end discs of the disc pack 18. The discs 24 and 26 are also referred to as second discs. In the exemplary embodiment shown in FIG. 1, the discs 24 are outer discs, which are arranged on the outer disc carrier (disc carrier 16), just like the end discs 20 and 22 designed as outer discs. In particular, the discs 20, 22 and 24 are supported on the outer disc carrier in the circumferential direction extending around the axial direction of the multiple-disc coupling 14, and are thereby coupled to the outer disc carrier in a torque-transmitting manner, in particular for conjoint rotation, in particular for torques extending around the axial direction of the multiple-disc coupling 14. The discs 26 are inner discs which are arranged on the inner disc carrier (disc carrier 17). The inner discs are supported on the inner disc carrier in the circumferential direction of the multiple-disc coupling 14, and therefore are coupled in a torque-transmitting manner to the inner disc carrier, in particular for conjoint rotation. The inner discs and outer discs are arranged sequentially alternating in the axial direction of the multiple-disc coupling 14. The initially disengaged multiple-disc coupling 14 is engaged, for example, by the multiple-disc coupling 18 in particular with the discs 26, i.e., the discs 20, 22, 24 and 26, being compressed, i.e., pressed together, in the axial direction of the multiple-disc coupling 14. The initially engaged multiple-disc coupling 14 is disengaged by, for example, the discs 20, 22, 24, 26 of the disc pack 18 being moved away from each other in the axial direction of the multiple-disc coupling 14. This takes place by means of an axial impact acting in the axial direction onto the disc pack 18 with the discs 26, which, for example, is brought about by an axial force acting in the axial direction onto the disc pack 18 with the discs or is such an axial force. The end disc 20 is also referred to as a first end disc 21, and the end disc 22 is also referred to as a second end disc 23. When reference is made in the following to the disc pack 18, this is to be understood as the disc pack 18 comprising the discs 20, 22, 24, and 26.

The transmission device 10 has a first switching element 28, by means of which the disc pack 18 can be actuated in a first actuating direction extending in the axial direction of the multiple-disc coupling 14, illustrated by an arrow 30 in FIG. 1, and as a result can be compressed, for example, in order to engage the multiple-disc coupling 14. In particular, the switching element 28 can exert a first force onto the first end disc 21, illustrated by the arrow 30, in the first actuating direction, illustrated by the arrow 30, and via this onto the disc pack 18, in order to compress the disc pack 18, for example, and thus to engage the initially disengage multiple-disc coupling 14.

The transmission device 10 has a second switching element 34, in particular provided in addition to the first switching element 28, which lies opposite the first switching element 28 in the axial direction of the multiple-disc coupling 14. The disc pack 18 can be actuated by means of the second switching element 34 in a second actuating direction, extending in the axial direction of the multiple-disc coupling 14 and counter to the first direction, illustrated by an arrow 36. For this purpose, the second switching element 34 can exert a second force on the second end disc 23 in the second actuating direction and via the second end disc 23 also on the disc pack 18, which second force is, for example, the aforementioned axial force or the aforementioned axial impact or functions as the aforementioned axial impact. Thus, the switching element 34 can disengage the multiple-disc coupling 14, for example. It can be seen that the disc pack 18 can be actuated by means of the switching element 32 in the second actuating direction via the second end disc 23, in particular to disengage the multiple-disc coupling 14 thereby.

The second end disc 23 is supported directly on the outer disc carrier in the second actuating direction and directly on a component 40 of the second switching element 34 in the first actuating direction. The component 40 supported directly on the second end disc 23 in the second actuating direction is supported directly on a securing element 42 in the first actuating direction, which is fixed at least indirectly, in particular directly, on a carrier element 44 of the transmission device 10 in the axial direction of the multiple-disc coupling 14, in particular in such a way that relative movements taking place in the axial direction of the multiple-disc coupling 14 between the carrier element 44 and the securing element 42 are omitted. In the exemplary embodiment shown in FIG. 1, the carrier element 44 is the housing 12. Alternatively, it would be conceivable that the carrier element 44 is designed separate from the housing 12 and is connected to the housing 12.

In the exemplary embodiment shown in FIG. 1, the securing element 42 is designed as a wedge ring having wedge surfaces 46 and 48 facing away from each other in the axial direction of the multiple-disc coupling 14, which extend outwards towards each other in the radial direction of the multiple-disc coupling 14.

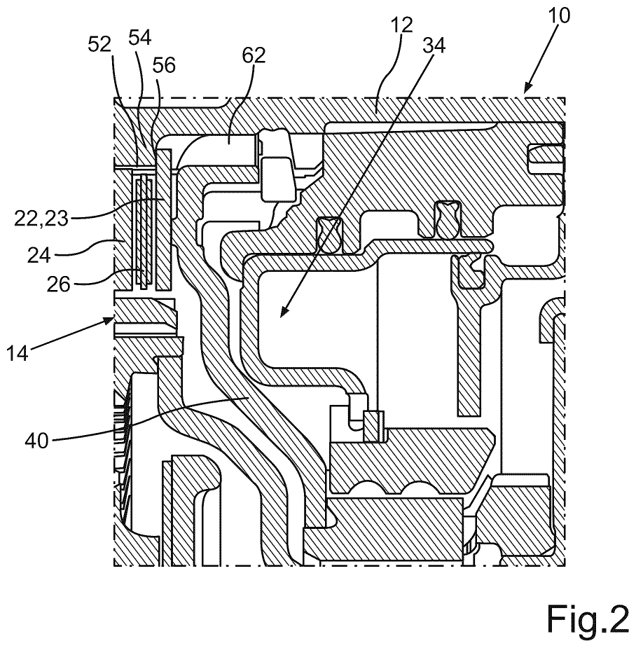

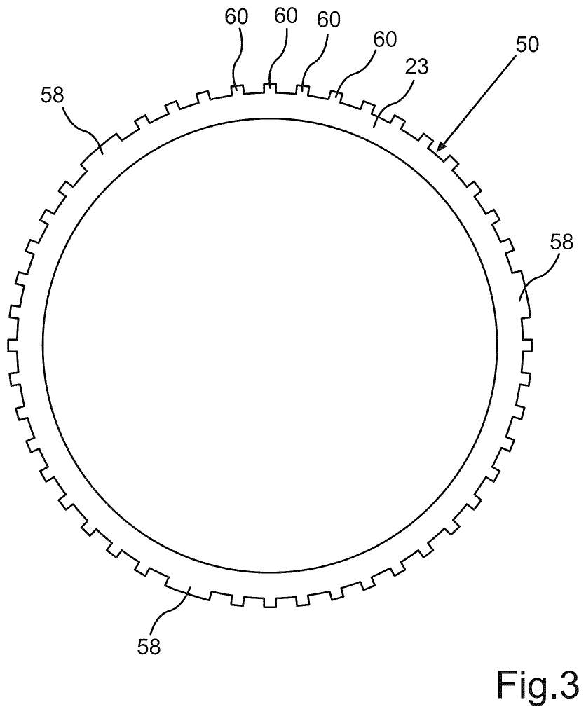

FIG. 3 shows the second end disc 23 in a schematic front view. As can be seen using the example of the second end disc 23, the discs 20, 22, and 24 of the disc pack 18 each have a first toothing 50, which is designed as outer toothing. The outer disc carrier has a second toothing, corresponding to the respective, first toothing 50, which is designed as inner toothing. The second toothing can partially be seen from FIG. 2 and there is labelled with 52. The toothings 50 and 52 engage into each other so that the discs 20, 22, and 24 of the disc pack 18 are engaged with the outer disc carrier via the toothing 50 and 52.

It can be seen particularly well from FIG. 2 that the second toothing 50 has at least or exactly two, in particular at least or exactly three, teeth set back in the axial direction of the multiple-disc coupling 14, of which one tooth labelled with 54 in FIG. 2 can be seen. This means that the respective tooth 54 forms a respective axial end face 56 as an abutment face, wherein teeth 58 of the first toothing 50 of the second end disc 23, which correspond to the end faces 56, are directly supported in the second actuating direction. It can be seen from FIG. 3 that the teeth 58 of the toothing 50 that are supported directly on the end faces 56 in the second actuating direction each have a first extension extending in the circumferential direction of the multiple-disc coupling 14, which is greater than a respective second extension of, in particular all, further teeth 60 of the toothing 50, the second extension extending in the circumferential direction of the multiple-disc coupling 14. It can also be seen from FIG. 3 that the teeth 58 and thus the end faces 56 are arranged evenly distributed in the circumferential direction of the multiple-disc coupling 14 extending around the axial direction, so that, for example, the teeth 58 are spaced apart from each other in pairs by 120 degrees in the circumferential direction of the multiple-disc coupling 14.

Furthermore, it can be seen from FIG. 2 that the component 40 of the second switching element 34 has a third toothing 62, which corresponds to the second toothing 52 and engages into the second toothing 52, whereby the component 40 and thus the second switching element 34 is supported on the disc carrier 16 and thus on the housing 12 in the circumferential direction of the multiple-disc coupling 14, in particular in such a way that the component 40 and thus the second switching element 34 is connected to the outer disc carrier for conjoint rotation, and thus to the housing 12 for conjoint rotation. The component 40 is a carrier, for example, in particular a sliding sleeve carrier. In particular, the wedge ring enables backlash-free adjustment, in particular via the second end disc 23.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE NUMERALS

10 transmission device
12 housing
14 multiple-disc coupling
16 first disc carrier
17 second disc carrier
18 disc pack
20 disc
21 first end disc
22 disc
23 second end disc
24 disc
26 disc
28 first switching element
30 arrow
32 arrow
34 second switching element
36 arrow
38 arrow
40 component
42 securing element
44 carrier element
46 wedge face
48 wedge face
50 first toothing
52 second toothing
54 tooth
56 end face
58 tooth
60 tooth
62 third toothing

1-8. (canceled)

9. A transmission device for a drive train of a motor vehicle, the transmission device comprising:
a multiple-disc coupling comprising at least one disc carrier and a disc pack with a plurality of discs arranged following each other in an axial direction of the multiple-disc coupling, wherein the plurality of discs include first and second end disks between which remaining discs of the plurality of disks are arranged;
a first switching element configured to actuate the disc pack via the first end disc in an actuating direction extending in the axial direction of the multiple-disc coupling; and
a second switching element arranged opposite the first switching element in the axial direction of the multiple-disc coupling, wherein the second end disc is supported directly on the at least one disc carrier in a support direction extending in the axial direction of the multiple-disc coupling and counter to the actuating direction and is supported directly on a component of the second switching element in the actuating direction,
wherein the plurality of discs of the disc pack each have a first toothing engaging into a corresponding second toothing of the at least one disc carrier so that the plurality of discs of the disc pack are supported on the disc carrier in a circumferential direction of the multiple-disc coupling,
wherein the second toothing has at least two teeth set back in the axial direction and forming a respective axial end face, and
wherein, on the respective axial end faces, corresponding teeth of the first toothing of the second end disc are directly supported in the support direction.

10. The transmission device of claim 9, wherein the component supported directly on the second end disc in the support direction is supported in the actuating direction directly on a securing element fixed at least indirectly to a carrier element of the transmission device in the axial direction of the multiple-disc coupling.

11. The transmission device of claim 10, wherein the securing element is a wedge ring having two wedge faces facing away from each other in the axial direction of the multiple-disc coupling, wherein the two wedge faces extend outwards towards each other in a radial direction of the multiple-disc coupling.

12. The transmission device of claim 9, wherein the teeth of the first toothing of the second end disc that are supported on the end faces each have a first extension, extending in the circumferential direction of the multiple-disc coupling, which is greater than a respective second extension of further teeth of the first toothing of the second end disc, wherein the second extension extends in the circumferential direction of the multiple-disc coupling.

13. The transmission device of claim 12, wherein the teeth of the first toothing of the second end disc that are supported on the end faces are arranged evenly distributed in the circumferential direction of the multiple-disc coupling.

14. The transmission device of claim 9, wherein the component includes a third toothing, corresponding to the second toothing, that engages into the second toothing to support the component on the disc carrier in the circumferential direction of the multiple-disc coupling.

15. The transmission device of claim 9, wherein the second switching element is a claw switching element and the component is a carrier part of a claw switching element half of the claw switching element.

16. The transmission device of claim 9, wherein the first and second switching elements are brake switching elements.
